(19) United States
(12) Patent Application Publication
(10) Pub. No.: US 2017/0113550 A1
(43) Pub. Date: Apr. 27, 2017

(54) ROAD WARNING METHOD AND DEVICE

(71) Applicant: Leauto Intelligent Technology (BEIJING) Co., Ltd., Beijing (CN)

(72) Inventors: Wenrui LI, Beijing (CN); Kunsheng CHEN, Beijing (CN); Yong XU, Beijing (CN); Wei LIN, Beijing (CN); Peng LIU, Beijing (CN)

(21) Appl. No.: 14/960,326

(22) Filed: Dec. 4, 2015

(30) Foreign Application Priority Data
Oct. 21, 2015 (CN) 201510694774.3

(51) Int. Cl. B60K 35/00; G01S 19/13

(52) U.S. Cl. CPC B60K 35/00; G01S 19/13

(57) ABSTRACT

The embodiments of the present disclosure provide road warning method and device. The device includes: a screen; a receiving module, configured to receive warning contents and transmit the warning contents to a displaying module and a data processing module; a positioning module, configured to acquire position information of the screen and transmit the position information to the data processing module; a displaying module, configured to display the warning contents on the screen; a data processing module, configured to organize the warning contents and the position information into warning information and transmit the warning information to a transmitting module; and a transmitting module, configured to transmit the warning information to objective vehicles within a predefined distance range, wherein the objective vehicles include vehicles supporting V2X communication. The present disclosure can achieve effects of long communication distance, excellent warning effect and editable warning contents, effectively ensuring traffic safety.

### CROSS-REFERENCE TO RELATED APPLICATIONS

The present disclosure is based upon and claims priority to Chinese Patent Application No. CN201510694774.3 filed Oct. 21, 2015, the entire contents of all of which are incorporated herein by reference.

### TECHNICAL FIELD

The embodiments of the present disclosure relate to the field of transportation safety technologies and in particular to a road warning method and a road warning device.

### BACKGROUND

With a development of road industry and an increase of an amount of vehicles, quality of roads in use becomes gradually deteriorated due to friction and impact of wheels, erosion and weathering of natural forces (such as, rainstorm, flood, sandstorm, ice-snow, solarisation and ice-melting), human destruction and deficiencies left at the time of building. Therefore, in order to maintain performance of the roads and keep driving safe, comfortable and unimpeded, road maintenance has become a common task. During the road maintenance, a road maintenance warning is usually needed to remind passing vehicles to instantly slow down or changing lane.

In current road maintenance warning manner, mostly, a warning board is erected, wherein the warning board usually has black letters on yellow or white letters on blue and coated with reflective material to catch the driver's attention to achieve the purpose of warning. However, the warning board in the prior art has problems that it easily topples over, degraded low visibility in rain and snow and is shielded by vehicles ahead. Therefore, the driver cannot be warned in advance, resulting in traffic accidents and causing irreparable damages.

### SUMMARY

The embodiments of the present disclosure provide road warning method and device, to overcome shortages in the prior art that the warning distance of road warning board is short and easily influenced by environment and to achieve effects of long communication distance, excellent warning effect and editable warning contents, effectively ensuring traffic safety.

The embodiments of the present disclosure provide a road warning device which includes:

a screen;

a receiving module, configured to receive warning contents and transmit the warning contents to a displaying module and a data processing module;

a positioning module, configured to acquire position information of the screen and transmit the position information to the data processing module;

a displaying module, configured to display the warning contents on the screen;

a data processing module, configured to organize the warning contents and the position information into warning information and transmit the warning information to a transmitting module; and

a transmitting module, configured to transmit the warning information to objective vehicles within a predefined distance range, wherein the objective vehicles include vehicles supporting V2X communication.

The embodiments of the present disclosure also provide a road warning method which includes steps of:

receiving warning contents;

displaying the warning contents on a preset screen;

acquiring position information of the screen;

organizing the warning contents and the position information into warning information; and

transmitting the warning information to objective vehicles within a predefined distance range, wherein the objective vehicles include vehicles supporting V2X communication.

The embodiment of the present disclosure further discloses a road warning device, wherein, the device includes:

a screen;

at least one processor; and

a memory;

at least one instructions stored in the memory, when executed by the processor, the road warning device is made to implementing:

receiving warning contents;

displaying the warning contents on a preset screen;

acquiring position information of the screen;

organizing the warning contents and the position information into warning information; and

transmitting the warning information to objective vehicles within a predefined distance range, wherein the objective vehicles comprise vehicles supporting V2X communication.

The road warning method and device according to the embodiments of the present disclosure may receive the warning contents by the receiving module, acquire the position information of the screen by the positioning module, and organized the warning contents and the position information into the warning information by the data processing module. On one hand, the displaying module displays the warning contents on the screen; on the other hand, the transmitting module transmits the warning information to the objective vehicles supporting V2X communication within the predefined distance range. In two ways, it is possible to overcome shortages in the prior art that the warning distance in road construction is short and easily influenced by environment, so as to achieve effects of long communication distance, excellent warning effect and editable warning contents, effectively ensuring traffic safety.

### BRIEF DESCRIPTION OF THE DRAWINGS

In order to more apparently describe the technical schemes in the embodiments of the present disclosure or in the prior art, accompanying figures necessarily used in the description of the embodiments or the prior art will be simply explained hereinafter. Obviously, the accompanying figures described below will form the embodiments of the present disclosure. An ordinary person skilled in the art may conceive further figures in accordance with these accompanying figures without contributing creative labor.

FIG. 1 is a block diagram showing a road warning device according to an embodiment of the present disclosure;

FIG. 2 is a block diagram showing a road warning device according to another embodiment of the present disclosure; and

FIG. 3 is a flow chart showing an example of a road warning method according to an embodiment of the present disclosure.

FIG. 4 is a block diagram schematically showing the road warning device according to the present disclosure.

FIG. 5 is a schematic diagram showing a memory for saving or carrying instructions according to the present disclosure.

### DETAILED DESCRIPTION

In order that objectives, technical schemes and advantages of the embodiments of the present disclosure become more apparent, the technical schemes in the embodiments of the present disclosure will be thoroughly and completely described below in conjunction with the accompanying figures in the embodiments of the present disclosure. It is obvious that the embodiments described herein are some of embodiments of the present disclosure rather than entire embodiments. On the basis of the embodiments of the present disclosure, other embodiments conceived by an ordinary person skilled in the art without creative labor would all fall into the scope of the present disclosure.

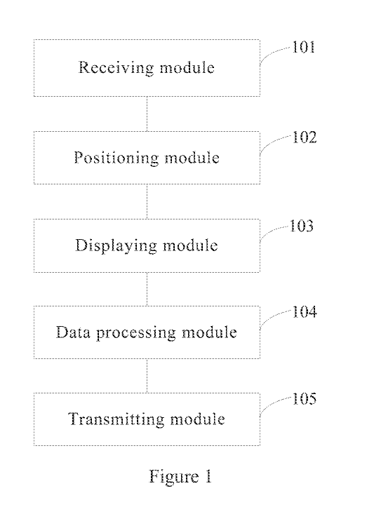

With reference to FIG. 1, it shows a block diagram of a road warning device according to an embodiment of the present disclosure. The device may particularly include following modules:

a screen (not shown);

a receiving module 101, configured to receive warning contents and transmit the warning contents to a displaying module and a data processing module;

a positioning module 102, configured to acquire position information of the screen and transmit the position information to the data processing module;

a displaying module 103, configured to display the warning contents on the screen;

a data processing module 104, configured to organize the warning contents and the position information into warning information and transmit the warning information to a transmitting module;

a transmitting module 105, configured to transmit the warning information to objective vehicles within a predefined distance range.

The objective vehicles may receive and display the warning information.

Herein, the objective vehicles may include vehicles supporting vehicle-to-infrastructural facilities (V2X, Vehicle to X) communication, which means the objective vehicles can support V2X communication.

In the embodiment of the present disclosure, the receiving module receives the warning contents, the positioning module acquires the position information of the screen, and the data processing module organizes the warning contents and the position information into warning information. On one hand, the displaying module displays the warning contents on the screen; on the other hand, the transmitting module transmits the warning information to the objective vehicles supporting V2X communication within the predefined distance range such that the objective vehicles receive and display the warning information. In two ways, it is possible to overcome shortages in the prior art that the warning distance in road construction is short and easily influenced by environment, so as to achieve effects of long communication distance, excellent warning effect and editable warning contents, effectively ensuring traffic safety.

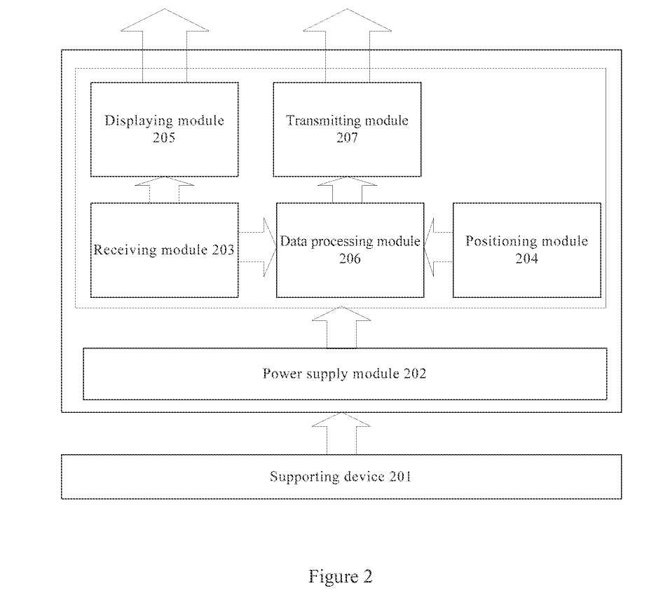

With reference to FIG. 2, it shows a road warning device according to an embodiment of the present disclosure. The road warning device may include a screen (not shown) and a supporting device 201 for supporting the screen.

In an embodied implementation, the screen may be an LED screen. The LED screen can include touch screen or non-touch screen.

The supporting device 201 is configured to support and fix the screen. The supporting device 201 may be similar to a traditional supporting device for a road safety warning board and substantially include a base, a supporting rod, a pulley and a connector(s).

Besides, the road warning device may at least further include following modules: a power supply module 202, a receiving module 203, a positioning module 204, a displaying module 205, a data processing module 206 and a transmitting module 207, which can be built in the supporting device 201, wherein

the power supply module 202 is configured to supply electric power to the road warning device.

In particular, the power supply module 202 can be used to provide the receiving module 203, the positioning module 204, the displaying module 205, the data processing module 206 and the transmitting module 207 with necessary electric energy for operation.

The power supply module 202 may include but not be limited to a rechargeable battery, a DC/AC device, wires, a switch, a plug and a transformer.

The receiving module 203 is configured to receive warning contents and transmit the warning contents to the displaying module 205 and the data processing module 206.

In an embodied implementation, warning contents may be input to the receiving module 203 in many manners, including but not limited to following three conditions.

In preferred one of the embodiments of the present disclosure, the road warning device may further include input equipment which is connectable to the screen. The receiving module 203 may further include a following sub-module:

a first receiving sub-module, configured to receive warning contents input by the user through the input equipment and transmit the warning contents to the displaying module and the data processing module.

In an embodied implementation, the input equipment may include input equipments such as mouse and keyboard. The input equipments such as mouse and keyboard may be connected to the screen via data cables.

In particular, the receiving module 203 may be embodied as an input interface in the screen. The user could input warning contents on the input interface through the mouse or keyboard and the first receiving sub-module can receive the warning contents input by the user.

In the application of the embodiment of the present disclosure, the user may include but not be limited to road maintenance personnel, transport management personnel or vehicle owner.

The warning contents may be contents input by the user according to specific road condition or construction condition for reminding other vehicle owners to notice road condition or change lane. For example, they could be “Tunnel is being constructed, please make a left/right/U turn”, “Expressway is being constructed, please change lane to left/right to make a detour, and the like.

In another preferred one of the embodiments of the present disclosure, when the screen is a touch screen, the receiving module 203 may further include a following sub-module:

a second receiving sub-module, configured to receive warning contents input by the user via the touch screen and transmit the warning contents to the displaying module and the data processing module.

In particular, the receiving module 203 may be embodied as an input interface in the screen. The user could input warning contents by clicking the input interface in the touch screen, and the second receiving sub-module can receive the warning contents input by the user via the touch screen.

In another preferred one of the embodiments of the present disclosure, the road warning device has intelligent terminal equipment connectable thereto and the receiving module 203 may further include a following sub-module:

a third receiving sub-module, configured to receive warning contents from the intelligent terminal equipment and transmit the warning contents to the displaying module and the data processing module.

In particular, the intelligent terminal equipment could include intelligent electronic equipment such as mobile phone, personal computer (PC) and tablet computer. The intelligent terminal equipment may be connectable to the road warning device in a wired or wireless manner. The user may edit the warning contents in the intelligent terminal equipment and then transmit them to the road warning device in a wired or wireless manner such that the warning contents can be received by the third receiving sub-module of the road warning device.

For example, the user could edit the warning contents on the mobile phone which is connected to the road warning device via WiFi or by scanning QR code; and then the user could transmit the edited warning contents to the road warning device.

As another example, the user can monitor the road condition in a computer room; when monitoring that a road has problems, the user can edit warning contents on a computer in the computer room such that the computer in the computer room can be connected to the road warning device in a wired or wireless manner; and then the user can transmit the edited warning contents on the computer in the computer room to the road warning device.

It should be explained, in the embodiment of the present disclosure, the intelligent terminal equipment could be placed in vicinity of the road warning device. For example, the mobile phone may be connectable to the road warning device via a data cable or by scanning QR code. Alternatively, a distance between the intelligent terminal equipment and the road warning device may be greater than a threshold; in this case, the intelligent terminal equipment is remote terminal equipment. For example, the user may connect the computer in the computer room to the road warning device. The distance between the intelligent terminal equipment and the road warning device is not restricted in the embodiments of the present disclosure as long as they could become connected.

After receiving the warning contents, the receiving module 203 can transmit the warning contents to the displaying module 205 and the data processing module 206.

The positioning module 204 is configured to acquire position information of the screen and transmit the position information to the data processing module 206;

In an embodied implementation, the positioning module 204 may include but not be limited to GPS (Global Positioning System), GNSS (Global Navigation Satellite System) and BDS (BeiDou Navigation Satellite System).

The positioning module 204 is able to real-time acquire the position information of the screen and transmit the position information to the data processing module 206.

The displaying module 205 is configured to display the warning contents on the screen.

In the application of the embodiment of the present disclosure, the displaying module 205 may receive the warning contents from the receiving module 203 and display the warning contents through the screen to play an external warning role.

The contents displayed on the screen by the displaying module 205 may be dependent on contents transmitted by the receiving module 203.

The data processing module 206 is configured to organize the warning contents and the position information as warning information and transmit the warning information to the transmitting module 207.

In practice, the data processing module 206 may include a microprocessor (or a microprocessor chip) supporting V2X communication and peripheral circuits. Herein, V2X (Vehicle to X) is key technology in an intelligent transportation system, which is able to come into communication between vehicles, between vehicles and base stations, and between base stations to obtain a series of traffic information such as real-time traffic condition, road information and pedestrian information, thereby improving driving safety, reducing congestion, improving transportation efficiency and providing vehicle entertainment information.

After receiving the warning contents from the receiving module 203 and the position information from the positioning module 204, the data processing module 206 can integrate the warning contents and the position information into warning information and transmit the warning information to the transmitting module 207.

In preferred one of the embodiments of the present disclosure, the data processing module 206 may include following sub-modules:

a splicing sub-module, configured to splice the warning contents and the position information; and

a packaging sub-module, configured to package the spliced warning contents and position information according to V2X protocol stack to generate the warning information.

In particular, the splicing sub-module may splice the received warning contents and position information and transmit a spliced result to the packaging sub-module, and the packaging sub-module may further package the spliced result into a format required by the V2X protocol stack to obtain the warning information.

The transmitting module 207 is configured to transmit the warning information to the objective vehicles within a predefined distance range.

In the embodiment of the present disclosure, the transmitting module 207 may at least include a RF (Radio Frequency) transmitting chip and a transmitting antenna supporting V2X communication.

In preferred one of the embodiments of the present disclosure, the transmitting module 207 may include a following sub-module:

a wireless transmitting sub-module, configured to periodically emit the warning information in a form of radio waves to the objective vehicles within the predefined distance range.

In the application of the embodiment of the present disclosure, the objective vehicles may include vehicles supporting V2X communication. In an implementation, the vehicles may be provided with V2X OBU (On Board Unit) to support the V2X communication.

After receiving the warning information from the data processing module 206, the transmitting module 207 can periodically emit the warning information to the outside in a form of radio waves in accordance with V2X technology rules, such that the objective vehicles within a predefined distance range can receive and display the warning information. Thus drivers can be early warned such that they have enough time to take actions and measures.

It should be explained that the predefined distance range may be a radio-frequency region of radio waves. In an embodied implementation, the predefined distance range according the embodiments of the present disclosure could be a wireless communication range of up to 1000 m in open environment and up to 300 m in urban intensive environment.

The transmitting module 207 according the embodiment of the present disclosure can support the V2X communication and support a wireless communication range of up to 1000 m in open environment and up to 300 m in urban intensive environment. In addition, signals transmitted by the transmitting module 207 are not be influenced by weather and blind angle, such that the objective vehicles can receive the warning information prior to the predefined distance range of the road warning device (for example, 1000 m), thereby perfectly completing a early-warning function to the driver of the objective vehicle. Therefore, the driver may have enough time to take actions and measures to reduce occurrence of traffic accidents. With the embodiment of the present disclosure, especially in the case that the warning board easily topples over, the visibility is degraded in rain or snow or slight is shielded by vehicles ahead, it is possible to provide early warning to reduce occurrence of traffic accidents.

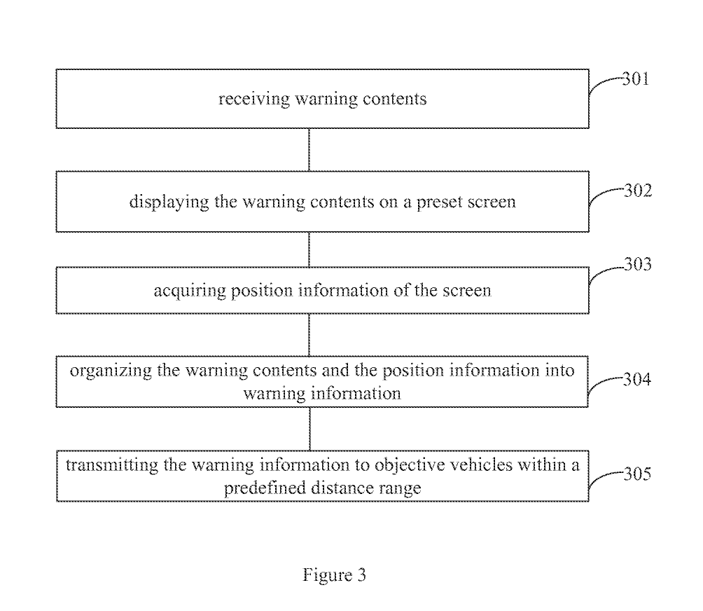

With reference to FIG. 3, it shows a flow chart showing an example of a road warning method according to an embodiment of the present disclosure. The method may particularly include steps of:

Step 301, receiving warning contents;

Step 302, displaying the warning contents on a preset screen;

Step 303, acquiring position information of the screen;

Step 304, organizing the warning contents and the position information into warning information; and

Step 305, transmitting the warning information to objective vehicles within a predefined distance range, wherein the objective vehicles include vehicles supporting vehicle-to-infrastructural facilities (V2X, Vehicle to X) communication.

In preferred one of the embodiments of the present disclosure, Step 304 may further include following sub-steps:

Sub-Step S11, splicing the warning contents and the position information; and

Sub-Step S12, packaging the spliced warning contents and position information according to the V2X protocol stack to generate the warning information.

In preferred one of the embodiments of the present disclosure, Step 305 may further include a following sub-step:

periodically emitting the warning information in a form of radio waves to the objective vehicles within the predefined distance range.

In preferred one of the embodiments of the present disclosure, Step 301 may further include a following sub-step:

receiving the warning contents input by a user via input equipment.

Herein, the input equipment may be keyboard, mouse and the like.

In another preferred one of the embodiments of the present disclosure, the screen may be a touch screen, and Step 301 may further include a following sub-step:

receiving the warning contents input by a user via a touch screen.

In another preferred one of the embodiments of the present disclosure, Step 301 may further include a following sub-step:

receiving the warning contents transmitted by intelligent terminal equipment.

Since the method embodiment in relation to FIG. 3 is substantially similar to the device embodiment as described, the description thereof is relatively simple. For the method embodiment, reference can be made to related parts of the device embodiment.

Each member embodiment of the present disclosure can be realized by hardware, or realized by software modules running on one or more processors, or realized by the combination thereof. A person skilled in the art should understand that a microprocessor or a digital signal processor (DSP) may be used in practical use to realize some or all the functions of some or all the members of the device according to the embodiments of the present disclosure. The present disclosure may be further realized as some or all the equipments or device programs for executing the methods described herein (for example, computer programs and computer program products). This program for realizing the present disclosure may be stored in computer readable medium, or have one or more signal forms. These signals may be downloaded from the Internet website, or be provided by carrying signals, or be provided in any other manners.

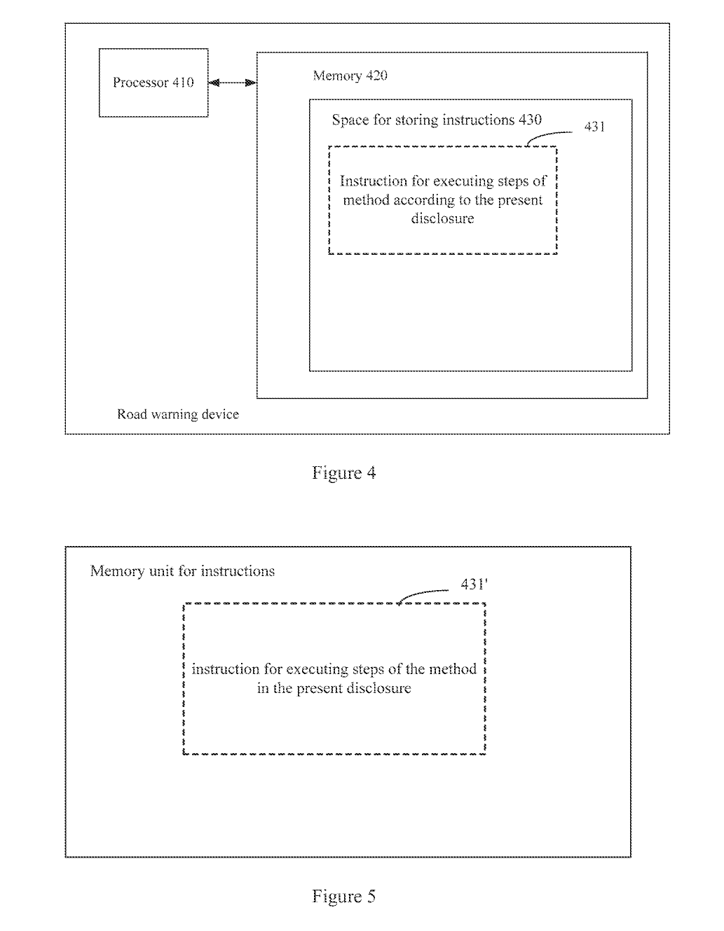

For example, FIG. 4 is a block diagram schematically showing a road warning device according to an embodiment of the present disclosure. The device conventionally includes a processor 410 and a computer program product or computer readable medium in the form of memory 420. The memory 420 may be an electronic memory such as a flash memory, EEPRPOM (electrically erasable programmable read-only memory), EPROM (electrically programmable read-only memory), hard disk or ROM (read-only memory). The memory 420 has a memory space 430 for storing instructions for executing any of the steps in the above method. For example, the memory space 430 for storing the instructions may include each instruction 431 for realizing steps in the above methods respectively. The instruction may be read out from one or more computer program product or write in one or more computer program product. The computer program product includes instruction carrier such as hard disk, compact disk (CD), storage card, or soft disk. The computer program product is usually a portable or non-portable memory unit shown in FIG. 5. The memory unit may have similar-arranged memory paragraph, memory space and the like as the memory 420 of the device for controlling the operation of in-vehicle infotainment in FIG. 5. The instructions may be, for example, compacted in appropriate form. Generally, the memory unit includes a computer readable code 431′, that is, the code which may be read by processor such as the processor 410. When the instruction is executed by the device for controlling the operation of in-vehicle infotainment, the device for controlling the operation of in-vehicle infotainment is made to execute the steps in the methods above.

The above embodiment of device is described merely for a schematic purpose, wherein the units explained as individual members may or may not be physically separated, the members shown as units may or may not be physical units and they can be placed at a position or also can be distributed to network units. As necessary in practice, some or all of the modules can be selected to complete the objectives of the schemes of the embodiments. An ordinary person skilled in the art may understand and implement the embodiments without contributing creative labor.

Through above description of the implementations, it is obvious for the skilled in the art that the implementations can be completed by means of software in connection with necessary universal hardware platform or of course by means of hardware. Based on this understanding, the essence of aforesaid technical schemes or the part contributing to the prior art can be embodied in a form of software product. The computer software product can be stored in computer readable storage medium, such as ROM/RAM, magnetic disc, compact disc and the like, which contains a plurality of instructions such that a computing device (such as, personal computer, server or network apparatus) is able to execute the methods as described in the embodiments or a portion of the embodiment.

In the end, it should be explained that aforesaid embodiments are provided for the purpose of illustrating not limiting the technical schemes of the present disclosure. Although the present disclosure has been described in detail with reference to the embodiments, it should be understood that modifications or equivalent substitutions can be made to the technical schemes or some of technical features therein as disclosed in the embodiments by those skilled in the art; the modifications or substitutions will not bring the essence of the respective technical schemes to depart from spirit and scope of the technical schemes of the inventive embodiments.

1. A road warning device, wherein, the device comprises:
a screen;
a receiving module, configured to receive warning contents and transmit the warning contents to a displaying module and a data processing module;
a positioning module, configured to acquire position information of the screen and transmit the position information to the data processing module;
a displaying module, configured to display the warning contents on the screen;
a data processing module, configured to organize the warning contents and the position information into warning information and transmit the warning information to a transmitting module; and
the transmitting module, configured to transmit the warning information to objective vehicles within a predefined distance range, wherein the objective vehicles comprise vehicles supporting V2X communication.

2. The device according to claim 1, wherein, the device further comprises:
a supporting device, configured to support the screen.

3. The device according to claim 2, wherein, the receiving module, the positioning module, the displaying module, the data processing module and the transmitting module are built in the supporting device.

4. The device according to claim 1, wherein, the device further comprises:
a power supply module, configured to supply electric power to the road warning device.

5. The device according to claim 1, wherein, the device further comprises input equipment which is connectable to the screen, and the receiving module comprises:
a first receiving sub-module, configured to receive warning contents input by the user through the input equipment and transmit the warning contents to the displaying module and the data processing module.

6. The device according to claim 1, wherein, the screen is a touch screen, and the receiving module comprises:
a second receiving sub-module, configured to receive warning contents input by the user via the touch screen and transmit the warning contents to the displaying module and the data processing module.

7. The device according to claim 1, wherein, the road warning device has intelligent terminal equipment, and the receiving module comprises:
a third receiving sub-module, configured to receive warning contents from the intelligent terminal equipment and transmit the warning contents to the displaying module module and the data processing module.

8. The device according to claim 1, wherein, the data processing module comprises:
a splicing sub-module, configured to splice the warning contents and the position information; and
a packaging sub-module, configured to package the spliced warning contents and position information according to V2X protocol stack to generate the warning information.

9. The device according to claim 1, wherein, the transmitting module comprises:
a wireless transmitting sub-module, configured to periodically emit the warning information in a form of radio waves to the objective vehicles within the predefined distance range.

10. A road warning method, wherein, the method comprises steps of:
receiving warning contents;
displaying the warning contents on a preset screen;
acquiring position information of the screen;
organizing the warning contents and the position information into warning information; and
transmitting the warning information to objective vehicles within a predefined distance range, wherein the objective vehicles comprise vehicles supporting V2X communication.

11. The method according to claim 10, wherein, the step of organizing the warning contents and the position information into warning information comprises:
splicing the warning contents and the position information; and
packaging the spliced warning contents and position information according to the V2X protocol stack to generate the warning information.

12. The method according to claim 10, wherein, the step of transmitting the warning information to objective vehicles within a predefined distance range comprises:
periodically emitting the warning information in a form of radio waves to the objective vehicles within the predefined distance range.

13. The device according to claim 2, wherein, the device further comprises:
a power supply module, configured to supply electric power to the road warning device.

14. The device according to claim 3, wherein, the device further comprises:
a power supply module, configured to supply electric power to the road warning device.

15. The device according to claim 10, wherein, the transmitting module comprises:
a wireless transmitting sub-module, configured to periodically emit the warning information in a form of radio waves to the objective vehicles within the predefined distance range.

16. The method according to claim 14, wherein, the step of transmitting the warning information to objective vehicles within a predefined distance range comprises:
periodically emitting the warning information in a form of radio waves to the objective vehicles within the predefined distance range.

17. A road warning device, wherein, the device comprises:
a screen;
at least one processor;
a memory;
at least one instructions stored in the memory, when executed by the processor, the road warning device is made to implementing:
receiving warning contents;
displaying the warning contents on a preset screen;
acquiring position information of the screen;
organizing the warning contents and the position information into warning information; and
transmitting the warning information to objective vehicles within a predefined distance range, wherein the objective vehicles comprise vehicles supporting V2X communication.
